(19) United States
(12) Patent Application Publication
(10) Pub. No.: US 2003/0013503 A1
(43) Pub. Date: Jan. 16, 2003

(54) Intercom module for a wireless system

(75) Inventors: Raymond J. Menard, Hastings, MN (US); Curtis E. Quady, Burnsville, MN (US)

Correspondence Address: Schwegman, Lundberg,, Woessner & Kluth, P.A., P.O. Box 2938, Minneapolis, MN, 55402, US

(73) Assignee: Royal Thoughts, L.L.C.

(21) Appl. No.: 09/906,383

(22) Filed: Jul. 16, 2001

(51) Int. Cl. H04M 1/00

(52) U.S. Cl. 455/569; 455/416

(57) ABSTRACT

A wireless intercom system having a BLUETOOTH® enabled transceiver. Voice recognition programming allows the user to select or control the operation of a particular intercom unit. User operable selections or controls allow specifying the target unit for communicating, selecting a threshold level for a squelch circuit, engaging a monitor function of the local unit or a remote unit, transmitting a page command, or other user operable function. In one embodiment, the intercom is adapted for wall mounting using a standard electrical box listed by Underwriters Laboratories Inc. In one embodiment, the transceiver is compatible with both a short range communication protocol and a long range communication protocol. In one embodiment, a compatible wireless repeater extends the range of the intercom by coupling with a long range communication network such as a cellular telephone network, pager network, or Internet.

### TECHNICAL FIELD

The present invention relates generally to the field of wireless communications and, in particular, to a system and method of communicating using a wireless intercom.

### BACKGROUND

Intercom systems are typically found in residential homes, apartment buildings, or offices. In the residential setting, for example, a main console station, or master unit, is often located in a kitchen area and one or more secondary stations, or slave units, are positioned throughout the house. A slave unit, for example, may be located at a front entry door to the house. To initiate a call from one station to another, a user pushes a button on the housing of the calling unit. The call is answered after the called party pushes a reply button on the called unit. To carry on a conversation using some systems, each party must then push a button to talk in order to have their voice carried to the other location.

Intercom systems may be classified as either wired or wireless. Wired systems have a network of wires, often carrying a low voltage signal, coupling the various stations throughout the house. Wireless systems use a radio frequency transceiver to link the various stations.

Drawbacks of known wired intercom systems include the following. First, the costs associated with installing and maintaining a network of interconnect wires may be prohibitive. Second, the costs associated with manufacturing and installing manual push buttons, such as the push-to-talk (PTT) switch, are also excessive. Third, the lack of portability, mandated by the wired nature of the system, tends to limit the functionality of the system. Fourth, to receive a call, a user must remain within hearing range of the called unit, and thus, the incoming call signaling method further limits the mobility of the called party.

Wireless systems ameliorate some of the problems associated with wired intercom systems, however, formidable drawbacks remain. For example, wireless systems typically lack sufficient range to allow long distance communications. Some intercom systems require that all units (sometimes referred to as transceivers) are plugged into an electrical service originating from a common power transformer. This limitation imposes a restriction on the range of the units. Also, wireless systems use PTT buttons, and other manual controls. Furthermore, most units tend to be large and thus rather obtrusive for discrete installations. Also, many wireless intercom systems operate in a half duplex mode, meaning that only one party can speak at a time.

For the reasons stated above, and for other reasons stated below which will become apparent to those skilled in the art upon reading and understanding the present specification, there is a need in the art for an improved intercom system. The system should overcome the problems enumerated above and provide additional benefits beyond those of known systems.

### SUMMARY

The above mentioned problems are addressed by the present invention and will be understood by reading and studying the following specification. A system and method is described which provides an intercom system having improved range, lower cost and enhanced functionality.

In one embodiment, the system includes an intercom unit having a microphone, a speaker, an audio amplifier, a processor and a BLUETOOTH® transceiver. BLUETOOTH® refers to a wireless, digital communication protocol using a miniature transceiver that operates at a frequency of around 2.45 GHz. BLUETOOTH® transceivers have a range of approximately 10 to 100 meters (and sometimes more) and by combining several BLUETOOTH® transceivers in an ad hoc network, the communication range can be extended indefinitely. The communication range can also be extended by coupling a BLUETOOTH® transceiver with a second transceiver coupled to a long range network, such as a cellular telephone network or pager network. Thus, an intercom unit as described can be used to link with other devices, such as a cellular telephone, a two way pager, a personal data (or digital) assistant (PDA), or a personal computer via the Internet.

Voice recognition programming executing on the processor of the intercom unit allow hands free operation. Also, the multiple channel capability of BLUETOOTH® allows full duplex conversations between parties and multiple simultaneous independent conversations within a network of intercom units. Voice recognition programming also allows the user to select a particular unit with which to open a communication channel.

In one embodiment, an intercom unit can operate as a room monitor or baby monitor. An adjustable squelch circuit allows the user to select a sound pressure level in the monitored room below which the intercom does not transmit and sounds exceeding this level are transmitted. Thus, a parent can adjust the intercom unit to mask the sound of an infant snoring but capture the sounds of a cry.

In one embodiment, one intercom unit can be used to page another intercom unit. Thus, a child being monitored by a parent can page the parent if needed. The paged intercom unit may sound a distinct tone, vibrate, illuminate a light, or display a distinct graphical image on a screen. Also, in one embodiment, a remote parent using an intercom unit, or other portable device, can open a communication channel with a selected intercom unit and thus, remotely activate a room monitoring function.

In one embodiment, the intercom unit is powered by a metered electric service which is typically 110 volts AC in the United States. The intercom unit may be powered by a rechargeable or non-rechargeable battery. In one embodiment, the intercom unit is built into a housing that mounts to a wall using a standard electrical box listed by Underwriters Laboratories Inc. For example, the unit may be integrated with an electrical switch, an electrical outlet or a blank decorative cover plate. In one embodiment, the intercom uses an adjacent wall surface as a diaphragm for a speaker or microphone. In the case of a speaker, a vibrating mass may be coupled to a wall surface and the mass is driven by magnetic forces. In the case of a microphone, vibrations of the wall may be detected and electrically coupled to the intercom unit.

### BRIEF DESCRIPTION OF THE DRAWINGS

FIG. 1 illustrates an embodiment of the present system having an electric switch.

FIG. 2 illustrates an embodiment of the present system having an electrical outlet.

FIG. 3 illustrates an embodiment of the present system for wall mounting.

FIG. 4 illustrates an embodiment of the present system.

FIG. 5 illustrates a block diagram of an embodiment of the present system.

FIG. 6 illustrates various methods of using an embodiment of the present system.

### DETAILED DESCRIPTION

In the following detailed description of the preferred embodiments, reference is made to the accompanying drawings which form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

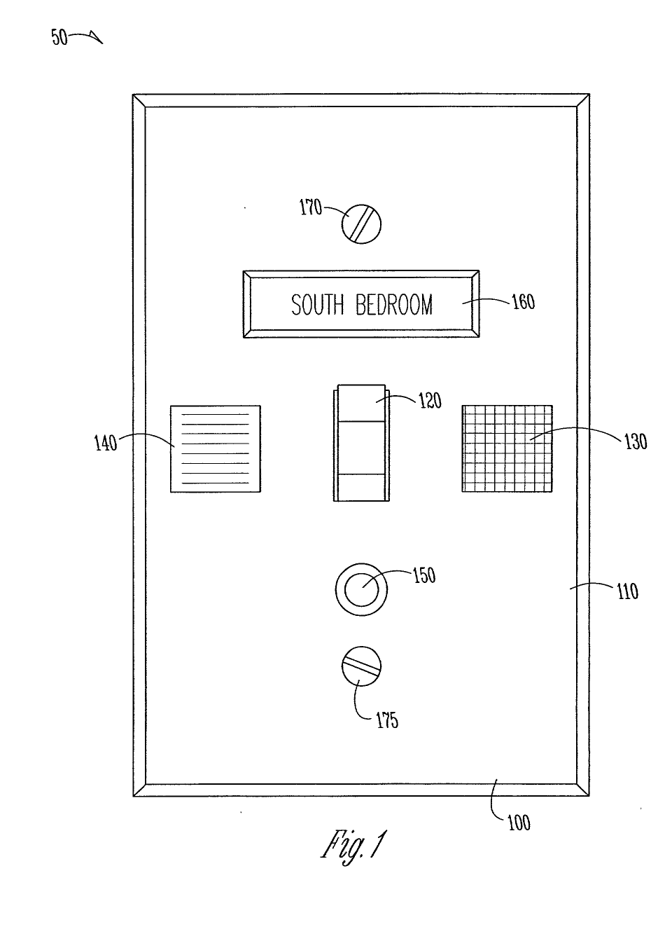

FIG. 1 schematically illustrates a block diagram of one embodiment of system 50. System 50 includes device 100 having coverplate 110 and electric switch 120. Coverplate 110 and electric switch 120 are mounted using an electric box listed by Underwriters Laboratories Inc. using mounting screws 170 and 175. Microphone 140, speaker 130, display 160, and control 150 are coupled to a wireless transceiver, amplifier and processor, each of which are not visible in the figure. In one embodiment, display 160 includes a liquid crystal display (LCD) and control 150 includes a push-to-talk (PTT) switch. Display 160 may include other types of display elements, including, for example, a light emitting diode (LED) display. Coverplate 110 includes decorative features that may aesthetically complement other electrical devices in a room. Fasteners 170 and 175 may include threaded machine screws or other fasteners.

Consider the operation of the embodiment illustrated in FIG. 1. Switch 120 is connected to a lighting circuit and can be used to turn on or off a light fixture. Microphone 140 receives audible sounds and generates electrical signals that are wirelessly transmitted to a remote device. Audio signals from the remote device are wirelessly received by device 100 and played aloud using speaker 130. Display 160 provides a visual indication of the identity of the remote device. In the figure, display 160 indicates that device 100 is in communication with a device located in a south bedroom.

The operation of device 100, as illustrated in the figure, may be controlled by control 150 or by voice commands received by microphone 140. Control 150, herein illustrated as a PTT switch, may include a selector switch. Control 150 allows a user to select a mode of operation for device 100, select another device with which to communicate, or select operating parameters or establish a configuration. Also, voice commands recognized by device 100 allow a user to select a mode of operation for device 100, select another device or location with which to communicate, or select operating parameters or establish a configuration.

Device 100, in one embodiment, supports a paging function. The paging function may assist in locating and establishing communication with a remote device or person. For example, a child user of device 100 may page a remote parent by pushing control 150. Device 100 then transmits a wireless signal requesting a reply from the parent. The parent may be reached using a wireless device, a wired telephone, e-mail, or by other communication means. In one embodiment, the parent is carrying a device compatible with device 100 and when paged by the child, the parent's device emits a characteristic tone or signal. Similarly, a parent may page device 100 to determine the location of the child. The parent may send a page signal to device 100 using a wireless device, a wired telephone, e-mail or other communication means.

In one embodiment, switch 120 may include a toggle switch, a rheostat, a potentiometer, a push button, a rocker-type switch or a slide switch. Switch 120 may be coupled to an electric circuit to operate a light fixture, an appliance, an electrical outlet, or any other device or circuit.

In one embodiment, device 100 is adapted for installation in an electrical box. The electrical box may be one listed by UL or approved for use by another entity. In a typical installation, the electric box is mounted to a wall structure of a house or other building. The electrical box, sometimes referred to as a junction box, is typically made of metal or plastic and provides a source for connecting to metered electric service. Typically, the metered electric service is 110 volts AC, however, other electric services are also contemplated for powering device 100. For example, device 100 may be powered by a low voltage DC power supply.

In one embodiment, device 100 includes a portable module that may be plugged into a standard electrical outlet. In such an embodiment, device 100 draws power from the electric service. Device 100 is thus portable and can be relocated to suit the user's needs.

In one embodiment, microphone 140 includes an electret microphone element. Other microphones are also contemplated, including a dynamic microphone or a carbon microphone. In one embodiment, microphone 140 includes an element that couples to a wall or ceiling surface and provides an electric signal based on vibrations of the surface.

In one embodiment, speaker 130 includes a piezoelectric element that generates audio when excited by an electric signal. Other speakers, or transducers, are also contemplated, including, for example, a flat speaker or a moving coil speaker. In one embodiment, speaker 130 includes a driver coupled to a wall or ceiling surface. The driver vibrates the surface when excited by an electric signal. In one embodiment, speaker 130 and microphone 140 are combined in a single module which operates as a speaker when excited by an electrical signal and otherwise operates as a microphone.

One embodiment includes display 160. Display 160 may be an active matrix screen, LED screen, LCD screen, or other device for displaying numeric or alphanumeric characters or graphical data. Display 160 may indicate the identity, or location, of a remote device with which device 100 is in communication. Display 160 may indicate the status, mode, configuration, or condition of device 100.

One embodiment includes control 150. Control 150 may include a switch, such as a push button switch, a toggle switch, rotary switch or other type of switch. Control 150 may include a touch sensitive surface or other means of indicating a selection or controlling the operation of device 100.

FIG. 2 illustrates another embodiment of device 100. Device 100, in the figure shown, includes electrical outlet 125 and fitted coverplate 112. Electrical outlet 125 may include a duplex outlet having two receptacles for receiving an electrical appliance or cord. In the embodiment of FIG. 2, device 100 also includes microphone 140, speaker 130 and control 150, as previously described. Coverplate 112 is mounted to an electrical box using fastener 170 which may include a threaded machine screw or other fastener.

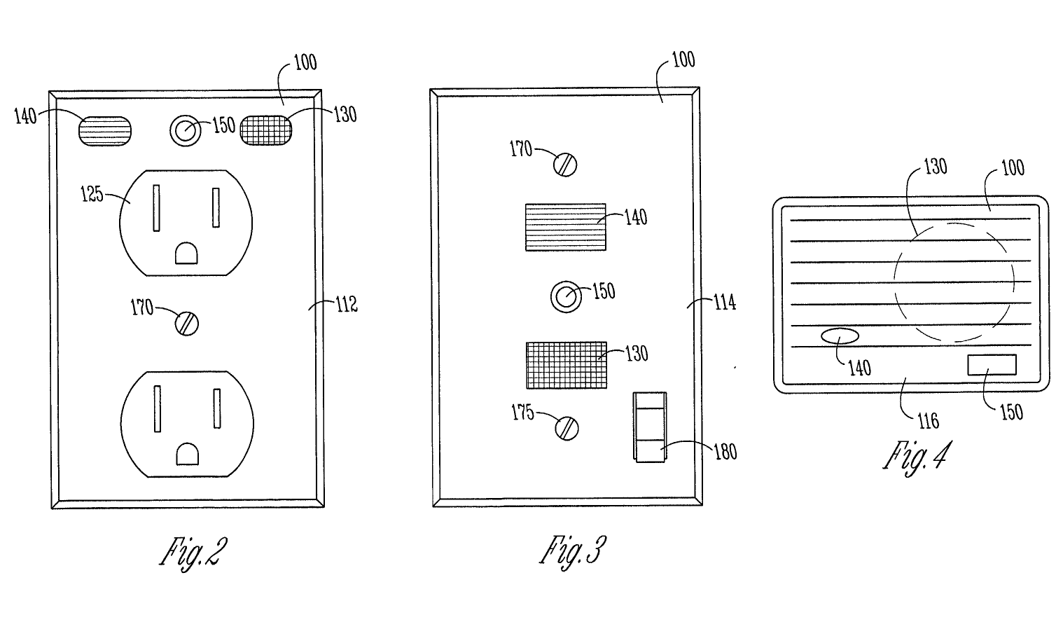

FIG. 3 illustrates another embodiment of device 100. Device 100, in the figure shown, includes coverplate 114. In the embodiment of FIG. 3, device 100 also includes microphone 140, speaker 130 and control 150, as previously described. Coverplate 114 is mounted to an electrical box using fasteners 170 and 175 which may include threaded machine screws or other fasteners.

In one embodiment, coverplate 114 includes electrical connector 180. Connector 180 may be adapted for receiving an electrical plug, or other matching connector. Connector 180 is coupled to interface circuitry of device 100, and in various embodiments, connector 180 may receive, or transmit, electrical signals to, or from, various other devices. For example, in one embodiment, connector 180 is adapted for exchanging an electrical signal with a security system, security sensor or detector. In one embodiment where connector 180 is adapted for receiving a signal from a separate passive infrared (PIR) motion detector, device 100 provides an interface for wirelessly communicating the detector information to a remote device. The signal generated by the motion detector may be a digital or analog signal. In one embodiment, connector 180 may allow a user to temporarily connect an external module to device 100. The external module may allow device 100 to be programmed to operate in a particular manner or it may facilitate diagnosis of device 100.

In one embodiment, device 100, when coupled to a PIR motion detector, may be configured to function as a security system or as an automatic control. For example, when the detector senses motion, processor 200 may instruct transceiver 210 to transmit an alarm signal. The alarm signal may be received by a remote device, and thus provide a means by which an emergency can be detected. In one embodiment, when the detector senses motion, an electrical appliance or device can be operated. For example, the light coupled to switch 120 (FIG. 1) or an appliance coupled to outlet 125 (FIG. 2) can be operated on an instruction from processor 200. An appliance, device, or other load can be controlled by processor 200 by using an electromechanical or semiconductor switching device. For example, processor 200 may be coupled to a silicon controlled rectifier (SCR) or an electromechanical relay operated by a magnetic field. Thus, the PIR motion detector can be used to trigger an alarm or to operate an appliance.

FIG. 4 illustrates an embodiment of device 100 having housing 116, microphone 140, speaker 130 and control 150. In one embodiment, electrical power may be provided by a power cord with a connector (not shown) or by a battery, or by both. The battery may be rechargeable using power drawn from the power cord. The battery may include a nickel-cadmium (nicad) battery. A door or other structure on device 100 may provide access to a battery compartment to allow user replacement of a battery. Housing 116 may be adapted for table top application or adapted for mounting to a wall or other surface.

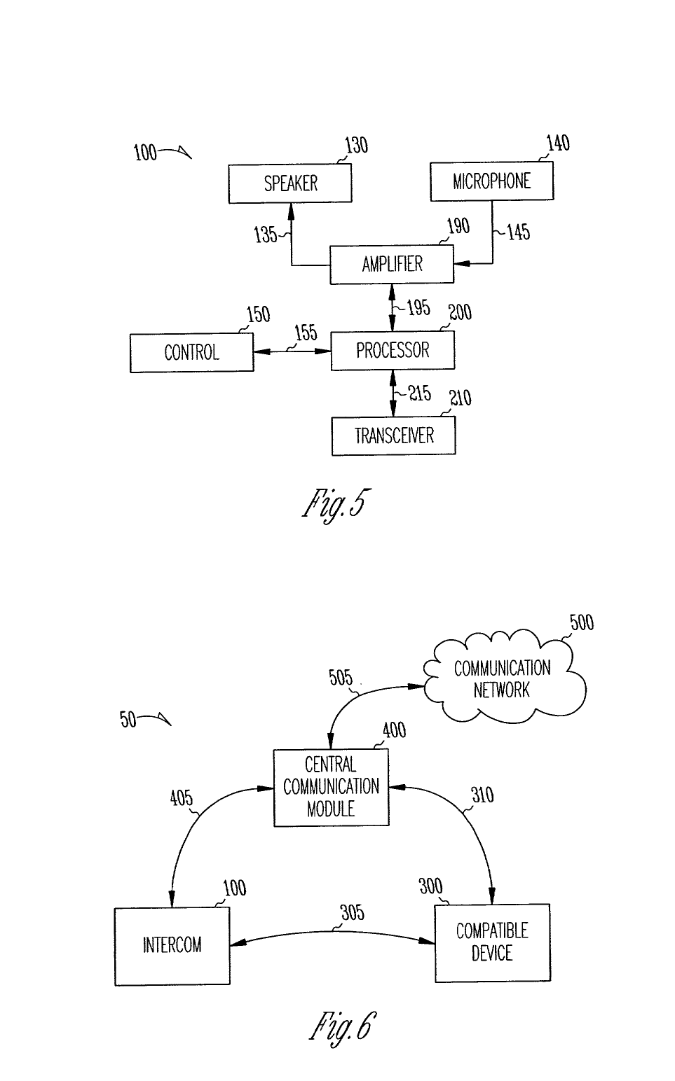

FIG. 5 illustrates a block diagram of one embodiment of device 100. In the figure, processor 200 is coupled to amplifier 190 by link 195. Amplifier 195 is coupled to speaker 130 by link 135 and to microphone 140 by link 145. Processor 200 is coupled to control 150 by link 155 and to transceiver 210 by link 215.

In the embodiment shown, speaker 130 may include any of the various transducers as described above. Speaker 130, in the block diagram shown, may include a digital to analog converter, in which case link 135 may convey digital data. In addition, link 135 may communicate power, an analog signal, or digital data. In one embodiment, link 135 communicates a signal corresponding to audio.

In the embodiment shown, microphone 140 may include various transducers as described above. Microphone 140, in the block diagram shown, may include an analog to digital converter, in which case, link 145 is a digital data line. Microphone 140 may include a preamplifier. In addition, link 145 may communicate power, an analog signal, or digital data. In one embodiment, link 145 communicates a signal corresponding to audio.

In the embodiment shown, amplifier 190 includes an audio amplifier. Amplifier 190 may amplify or process analog or digital data corresponding to audio in the frequency range of 20-20,000 Hz. Amplifier 190 may receive audio from microphone 140, on link 145, and after suitable amplification or signal processing, transmit the signal to processor 200 for further processing. Processor 200, may then communicate data based on the audio to transceiver 210 using link 215. Also, data received by transceiver 210 may be transferred to processor 200, using link 215, for processing and then subsequently to amplifier 190. Amplifier 190, after suitable amplification and processing, communicates the signal to speaker 130, using link 135, for playing. Amplifier 190 may include a preamplifier and may include discrete or integrated circuitry.

In one embodiment, processor 200 includes a microprocessor having a memory and an executable program with instructions for operating in the manner described herein. Processor 200 may include a programmable logic controller, logical gates or electrical circuits. Memory may include storage for program instructions and data. The memory may include random access memory (RAM), read only memory (ROM), or other type of nonremovable or removable storage media, such as, for example, COMPACTFLASH™ (Sandisk Corporation) or SMARTMEDIA™ (Kabushiki Kaisha Toshiba DBA Toshiba Corporation) or other such small form factor media. Processor 200 is coupled to amplifier 190 by link 195. Processor 200 may perform signal processing using, for example, data or signals received from amplifier 190, control 150 and transceiver 210. Processor 200 may provide data or signals to amplifier 190, control 150 and transceiver 210.

In one embodiment, processor 200 executes a voice recognition program. Voice recognition may allow a user to control the operation of device 100 based on a spoken word, sound, or phoneme. Sounds received at microphone 140, or other transducer coupled to device 100, may, for example, cause device 100 to establish a communication link with a particular device having a transceiver compatible with transceiver 210. The voice recognition program may execute instructions received from a voice which has particular predetermined characteristics. Depending upon the match requirements of the voice recognition program, device 100 may communication instructions upon recognizing a completely, or partially, matching voice.

In one embodiment, the voice recognition function is performed at a remote device. In such an embodiment, for example, processor 200 instructs transceiver 210 to transmit digital data representing voice to a remote device. The remote device, also compatible with the communication protocol of transceiver 210, decodes the data and using voice recognition programming, provides a command or instruction based on the digital data. The remote device wirelessly transmits the command or instruction to device 100 where it is executed, in part, by processor 200. In this manner, device 100 is responsive to voice commands.

Programming executing on processor 200 may permit a user to adjust tonal qualities of device 100, volume of speaker 130, or sensitivity of microphone 140. Adjusting the sensitivity of microphone 140, for example, may allow a user to implement a squelch control. For example, a user may adjust the sensitivity of microphone 140 to a level such that sounds below a particular sound pressure level do not generate an audio output and sounds in excess of that level are communicated by device 100. Device 100 may be monitored remotely by another compatible device and, in one embodiment, if device 100 is exposed to a sound pressure level that exceeds a particular level, then the compatible device responds by playing a characteristic audible tone or signal. The tone or signal indicates that the particular sound pressure level has been exceeded. This function may prove advantageous in a case where a user is interested in monitoring a room for the sound of a baby crying and in suppressing the sound of the baby sleeping or snoring. As a further example, a user with a cellular telephone can engage in a discussion with another person using device 100. As another example, a user with a cellular telephone can remotely monitor sounds near device 100.

Programming executing on processor 200 may also enable forwarding of data or signals. For example, a wireless signal received by transceiver 210 may undergo signal processing by processor 200 and subsequent retransmission using transceiver 210. In this manner, device 100 can extend the range of communication of another device.

Programming executing on processor 200 also enables device 100 to operate as a slave or master in an intercom system. For example, processor 200 may generate, and cause transceiver 200, to transmit a signal indicating the status of device 100 as a master or slave unit. A master unit has superior capabilities relative to that of the slave unit.

Programming executing on processor 200 may also enable device 100 to receive and store data and values related to the configuration of device 100. A user may enter configuration data and values into device 100 using transceiver 210 or by using a connector coupled to device 100. Multiple configurations may be established for a particular device 100. For example, a user may have established a first configuration wherein, unless otherwise specified, a recognizable voice command causes a first device 100 to always establish an intercom communication link with a particular second device 100. A second configuration may provide that, unless otherwise provided for, and during particular specified hours, a first device 100 is in communication with a third device 100.

Control 150 is coupled to processor 200 by link 155. Control 155, as previously described, may include a switch or other user operable control. In one embodiment, control 155 includes a keypad having a plurality of operable switches. The keypad may be hidden by a protective panel. Control 150 may also include a touch sensitive screen. Display 160 may include the touch sensitive screen. Processor 200 may generate images of operable keys and by manipulating the screen, a user may make selections for the operation and control of device 100. Control 150 communicates with transceiver 210 via processor 200.

Transceiver 210 is coupled to processor 200 by link 215. Transceiver 210, in one embodiment, is a spread spectrum frequency hopping transceiver. Transceiver 210 may communicate using a protocol compatible with BLUETOOTH®. BLUETOOTH® refers to a wireless, digital communication protocol using a low form factor transceiver that operates using spread spectrum frequency hopping at a frequency of around 2.45 GHz.

BLUETOOTH® is a trademark registered by Telefonaktiebolaget L M Ericsson of Stockholm, Sweden and refers to technology developed by an industry consortium known as the BLUETOOTH® Special Interest Group. BLUETOOTH® operates at a frequency of approximately 2.45 GHz, utilizes a frequency hopping (on a plurality of frequencies) spread spectrum scheme, and as implemented at present, provides a digital data transfer rate of approximately 1 Mb/second. In one embodiment, the present system includes a transceiver in compliance with BLUETOOTH® technical specification version 1.0, herein incorporated by reference. In one embodiment, the present system includes a transceiver in compliance with standards established, or anticipated to be established, by the Institute of Electrical and Electronics Engineers, Inc., (IEEE). The IEEE 802.15 WPAN standard is anticipated to include the technology developed by the BLUETOOTH® Special Interest Group. WPAN refers to Wireless Personal Area Networks. The IEEE 802.15 WPAN standard is expected to define a standard for wireless communications within a personal operating space (POS) which encircles a person. In one embodiment, the transceiver is a wireless, bidirectional, transceiver suitable for short range, omnidirectional communication that allows ad hoc networking of multiple transceivers for purposes of extending the effective range of communication. Ad hoc networking refers to the ability of one transceiver to automatically detect and establish a digital communication link with another transceiver. The resulting network, known as a piconet, enables each transceiver to exchange digital data with the other transceiver. According to one embodiment, BLUETOOTH® involves a wireless transceiver transmitting a digital signal and periodically monitoring a radio frequency for an incoming digital message encoded in a network protocol. The transceiver communicates digital data in the network protocol upon receiving an incoming digital message.

According to one definition, and subject to the vagaries of radio design and environmental factors, short range may refer to systems designed primarily for use in and around a premises and thus, the range generally is below a mile. Short range communications may also be construed as point-to-point communications, examples of which include those compatible with protocols such as BLUETOOTH®, HomeRF™, and the IEEE 802.11 WAN standard (described subsequently). Long range, thus, may be construed as networked communications with a range in excess of short range communications. Examples of long range communication may include, Aeris MicroBurst cellular communication system, and various networked pager, cellular telephone or, in some cases, radio frequency communication systems.

In one embodiment, transceiver 210 is compatible with both a long range communication protocol and a short range communication protocol. For example, a person located a long distance away, such as several miles, from device 100 may communicate with transceiver 210 using a cellular telephone compatible with the long range protocol of transceiver 210. In one embodiment, programming executing on processor 200 provides information to generate a message to be delivered to a remote cellular telephone. The message may appear on a display of the cellular telephone or it may appear as an audible sound or as an inaudible vibration of the cellular telephone.

In addition, feedback may be transmitted to a remote device based on the operation of device 100. For example, if a user issues a command to device 100 using the cellular telephone, then the display of the phone will indicate the changes arising from the command: In one embodiment, the cellular telephone, or other device, displays real time information from device 100.

FIG. 6 illustrates communication links operative with one embodiment of device 100. In the event that transceiver 210 includes a transceiver compatible with BLUETOOTH® protocol, for example, then device 100 may have sufficient range to conduct bidirectional communications over relatively short range distances, such as approximately 10 to 1,000 meters or more. In some applications, this distance allows communications throughout a premises. In the figure, device 100 is shown coupled to compatible device 300 by link 305. Compatible device 300 may be located within communication range of device 100 (for example, within approximately 10 meters) and may include an intercom unit, a headset, a computer, a pager, a cellular telephone, a personal data assistant (PDA), or other device having a transceiver compatible with BLUETOOTH®.

In one embodiment, device 100 communicates with a device referred to herein as central communication module 400. Central communication module 400 may include a first transceiver compatible with BLUETOOTH®. Module 400 may provide a repeater service to receive a message using BLUETOOTH® and to retransmit the message using a different communication protocol or also using BLUETOOTH® communication protocol. Module 400 may also include a second transceiver or a wired interface having access to another communication network. The second transceiver or wired interface may retransmit the signal received from device 100 or received from some other device. In this way, central communication module 400 may serve to extend the communication range of device 100. For example, a message between device 100 and a device coupled to communication network 500, in the figure, may be exchanged using central communication module 400 and link 505. Communications between device 100 and a device coupled to communication network 500 may be considered long range communications. Module 400 may also communicate bidirectionally with compatible device 300. Compatible device 300 may be a second device 100.

Network 500 may be a public switched telephone network (PSTN), a pager communication network, a cellular communication network, a radio communication network, the Internet, or some other communication network. It will be further appreciated that with a suitable repeater, gateway, switch, router, bridge or network interface, the effective range of communication of transceiver 210 may be extended to any distance. For example, module 400 may receive transmissions on a BLUETOOTH® communication protocol and provide an interface to connect with network 500, such as the public switched telephone network (PSTN) using link 505. In this case, a wired telephone at a remote location can be used to communicate with device 100. As another example, the range may be extended by coupling a BLUETOOTH® transceiver with a cellular telephone network, a narrow band personal communication systems (“PCS”) network, a CELLEMETRY® network, a narrow band trunk radio network or other type of wired or wireless communication network.

Various methods may be used to communicate with, or send a message or instruction to, device 100 from a remote location. For example, using a cellular telephone, a user may speak a particular phrase, word or phoneme that is recognized by the cellular telephone which then generates and transmits a coded message to device 100. As another example, the user may manipulate a keypad on the telephone to encode and transmit a message to device 100.

Examples of devices compatible with such long range protocols include, but are not limited to, a telephone coupled to the public switched telephone network (PSTN), a cellular telephone, a pager (either one way or two way), a personal communication device (such as a personal digital assistant, PDA), a computer, or other wired or wireless communication device.

Long range communication protocols may include, but are not limited to, cellular telephone protocols, one way or two way pager protocols, and PCS protocols. Typically, PCS systems operate in the 1900 MHZ frequency range. One example, known as Code-Division Multiple Access (CDMA, Qualcomm Inc., one variant is IS-95) uses spread spectrum techniques. CDMA uses the full available spectrum and individual messages are encoded with a pseudo-random digital sequence. Another example, Global Systems for Mobile communications (GSM), is one of the leading digital cellular systems and allows eight simultaneous calls on the same radio frequency. Another example, Time Division Multiple Access (TDMA, one variant known as IS-136) uses time-division multiplexing (TDM) in which a radio frequency is time divided and slots are allocated to multiple calls. TDMA is used by the GSM digital cellular system. Another example, 3G, promulgated by the ITU (International Telecommunication Union, Geneva, Switzerland) represents a third generation of mobile communications technology with analog and digital PCS representing first and second generations. 3G is operative over wireless air interfaces such as GSM, TDMA, and CDMA. The EDGE (Enhanced Data rates for Global Evolution) air interface has been developed to meet the bandwidth needs of 3G. Another example, Aloha, enables satellite and terrestrial radio transmissions. Another example, Short Message Service (SMS), allows communications of short messages with a cellular telephone, fax machine and an IP address. Messages are limited to a length of 160 alpha-numeric characters. Another example, General Packet Radio Service (GPRS) is another standard used for wireless communications and operates at transmission speeds far greater than GSM. GPRS can be used for communicating either small bursts of data, such as e-mail and Web browsing, or large volumes of data.

In one embodiment, a long range communication protocol is based on one way or two way pager technology. Examples of one way pager protocols include Post Office Code Standardisation Advisory Group (POCSAG), Swedish Format (MBS), the Radio Data System (RDS, Swedish Telecommunications Administration) format and the European Radio Message System (ERMES, European Telecommunications Standards Institute) format, Golay Format (Motorola), NEC-D3 Format (NEC America), Mark IV/V/VI Formats (Multitone Electronics), Hexadecimal Sequential Code (HSC), FLEX™ (Motorola) format, Advanced Paging Operations Code (APOC, Philips Paging) and others. Examples of two way pager protocols include ReFLEX™ (Motorola) format, InFLEXion™ (Motorola) format, NexNet™ (Nexus Telecommunications Ltd. of Israel) format and others.

In one embodiment, transceiver 210 is compatible with a two-way pager network thus allowing bidirectional communication between a BLUETOOTH®-enabled device 100 and a user controlled pager. In one embodiment, the long distance network may include a telephone network which may include an intranet or the Internet. Coupling to such a network may be accomplished, for example, using a variety of connections, including a leased line connection, such as a T-1, an ISDN, a DSL line, or other high speed broadband connection, or it may entail a dial-up connection using a modem. In one embodiment, the long distance network may include a radio frequency or satellite communication network. In addition, one or more of the aforementioned networks may be combined to achieve desired results.

Short range communication protocols, compatible with transceiver 210 may include, but are not limited to, wireless protocols such as HomeRF™, BLUETOOTH®, wireless LAN (WLAN), or other personal wireless networking technology. HomeRF™, currently defined by specification 2.1, provides support for broadband wireless digital communications at a frequency of approximately 2.45 GHz.

In one embodiment, transceiver 210 is compatible with a communication protocol using a control channel. One such example is CELLEMETRY®. CELLEMETRY® is a registered trademark of Cellemetry LLC of Atlanta, Ga., USA, and enables digital communications over a cellular telephone control channel. Other examples of communication technology are also contemplated, including MicroBurst™ technology (Aeris.net, Inc.).

Other long range and short range communication protocols are also contemplated and the foregoing examples are not to be construed as limitations but merely as examples.

Transceiver 210 may be compatible with more than one communication protocols. For example, transceiver 210 may be compatible with three protocols, such as a cellular telephone communication protocol, a two-way pager communication protocol, and BLUETOOTH® protocol. In such a case, a particular device 100 may be operable using a cellular telephone, a two-way pager, or a device compatible with BLUETOOTH®.

In one embodiment, device 100 can communicate with a remote device using more than one communication protocols. For example, device 100 may include programming to determine which protocol to use for communicating.

The determination of which communication protocol to use to communicate with a remote device may be based on power requirements of each transceiver, based on the range to the remote device, based on a schedule, based on the most recent communication from the remote device, or based on any other measurable parameter. In one embodiment, device 100 communicates simultaneously using multiple protocols.

In one embodiment, signals generated by device 100 are received by a central monitoring station. The central monitoring station may include operators that provide emergency dispatch services. An operator at the central monitoring station may also attempt to verify the authenticity of a received alarm signal. In one embodiment, the alarm signal generated by device 100 is first transmitted to a user, using either a short range or long range communication protocol, who then may forward the alarm signal to a monitoring station if authentic or cancel the alarm signal if the alarm is not valid.

In one embodiment, device 100 may communicate with a building control or security system by communicating using transceiver 210. For example, device 100 may operate as an auxiliary input to a building control or security system. In which case, if device 100 detects a security event, by way of a sensor coupled to device 100, then an alarm signal is transmitted from device 100, via transceiver 210, to the building security system. The building security system, if monitored by a central monitoring station, then forwards the alarm signal to the monitoring station. In one embodiment, device 100 can receive a transmission from a separate building control or security system. If the building security system detects an alarm condition, then the security system can, for example, instruct device 100 to repeatedly toggle power to load A flashing light visible from the exterior of the building may aid emergency personnel in locating an emergency site. Alternatively, device 100 can establish communications with a predetermined remote device or a central monitoring service.

In one embodiment, transceiver 210 includes an external, or remote, antenna. The remote antenna may provide an increased communication range. When mounted in a metal electrical box, shielding effects may reduce the communication range of transceiver 210.

Device 100 may function as a room monitor. In one embodiment, a remote device, which may be second device 100, sends a wireless message to a first device 100. The message may instruct first device 100 to receive local audio using microphone 140 and transmit digital data using transceiver 210 compatible with BLUETOOTH® protocol. Second device 100 may be configured to receive the wireless signals and reproduce the local audio using a speaker. In this way, a second device can be used to activate the room monitoring function of a first device 100 and receive local audio. The room monitoring function may allow a parent in one room, for example, to monitor a sleeping baby in a second room.

Device 100, in one embodiment, includes a squelch control. The squelch control may be engaged and adjusted manually using control 150, or it may be engaged and operated using a voice command. In one embodiment, the squelch control of a first device 100 may be engaged and adjusted using a compatible device, such as, for example, a second device 100.

In one embodiment, microphone 140 and speaker 130 allow device 100 to operate in a full duplex communication mode with another compatible device. For example, at a time when a first person is talking into microphone 140 of a first device 100, a second person can also be talking into a microphone 140 of a second device. Thus, speaker 130 in first device 100 and speaker 130 in second device 100 may produce sounds simultaneously. Echo cancellation circuitry or programming may prevent undesirable feedback from creating an objectionable ringing tone.

Sample Embodiment

The following embodiment provides a system and method for capturing, storing and retrieving visitor events. For example, the present system and method may provide functionality beyond that of a doorbell and wireless intercom.

In one embodiment, a signaling device is installed near an entry door. The device may replace the traditional doorbell or it may be installed in addition to the traditional doorbell. In one embodiment, the device draws electrical power from the doorbell circuit and includes a wireless transceiver compatible with BLUETOOTH® protocol which allows the device to communicate with a host controller. The host controller may be located on premises or it may be located at a remote location. In one embodiment, the host controller operates as a gateway to a telephone network.

Consider the operation of the present system. When a visitor operates the doorbell switch component of the device, a BLUETOOTH® protocol wireless signal is transmitted to the host controller which then operates a doorbell chime. The doorbell chime may be operated wirelessly or by a wired connection.

Under certain circumstances, the host controller of the present subject matter is adapted to dial a preprogrammed telephone number in an attempt to establish a communication link with a designated party. The designated party may be the owner of the premises, a resident of the premises, or some other designated party. In one embodiment, the host controller is adapted to dial the telephone number when a sensor indicates that the premises is vacant or pursuant to a schedule stored in a memory. An occupancy detector may provide information as to which programmed telephone number to use to contact the designated party. The host controller may attempt multiple telephone calls to multiple telephone numbers depending upon the programming executing on the present system.

In one embodiment, a BLUETOOTH® protocol audio link is established between the caller at the entry door and the designated party using a telephone. The BLUETOOTH® protocol link may be full duplex, thus facilitating a conversation between the caller and the designated party.

Further capabilities are also contemplated. For example, in one embodiment, the present system includes a message storage and retrieval function. In this embodiment, a caller is prompted to record a message for a designated party. The prompt may be in the form of a visual indicator or it may include an audible voice message played in the vicinity of the entry door. The caller is given the option to leave a message. In one embodiment, the caller may leave a message after determining that the designated party is unreachable or unavailable by telephone.

In one embodiment, the message storage function of the present system does not rely on the operation of a telephone answering machine or traditional voice mail service. Ordinarily, incoming telephone calls placed to a cellular telephone are received by a voice mail service and hence, the outgoing message prompting the caller to leave a message is typically tailored for a telephone environment. In contrast to ordinary voice mail, the message storage function of the present system is tailored to the needs of a caller at an entry door. In other words, the greeting message heard by a caller using the present system is appropriate for a visitor at the front door.

In addition, the present system allows a stored message to be retrieved without accessing a telephone voice mail message service. For example, in one embodiment, messages are stored in the local host controller and messages can be retrieved by accessing the controller or by coupling to the present system using a wired or wireless interface. More particularly, access to the stored messages is not limited to retrieval only by use of a telephone. Thus, the present subject matter avoids the complications arising from conflicts with answering machines and human operators answering a telephone.

In one embodiment, the present system includes a central host and database. The central host, or database, may be located at the site of the premises or it may be located remotely. A central host may be configured to provide messaging services for a plurality of doorbell systems. Remote location of the central host also permits the present system to be operated as a commercial service.

In one embodiment, a BLUETOOTH® protocol link is established when the door intercom button is operated. The BLUETOOTH® protocol link couples with a host controller and the host responds, in one embodiment, by generating a low volume chime signal. The low volume chime signal is adapted to be audible to a caller at the exterior of the premises, thereby acknowledging the action of pushing the button. If the host controller then determines that nobody is available to answer the door (for example, when the security alarm function is in the armed, or “away” mode), then the controller attempts to call a primary telephone number to establish a communication link. The primary telephone number may be a wired or cellular telephone number for a designated party. Assuming the designated party answers the telephone call, a synthesized or prerecorded voice message is generated by the host controller, thereby prompting the designated party to make a selection by pressing a particular DTMF key (or key sequence) on the telephone keypad. In one embodiment, by pressing “1,” the designated party is able to talk with the caller, by pressing “2,” the entry door is electronically unlocked, by pressing “3,” a message is solicited from the caller and the designated party is able to monitor the message, by pressing “4,” the message can be discarded, and by pressing “5,” the call can be terminated. Other functions can also be established.

In one embodiment, if the telephone call from the host controller to the designated party is not answered, then the host controller plays a stored outgoing message prompting the caller to leave a voice message. The message may be temporarily stored on the host controller. In one embodiment, after storing the message, the host controller terminates the call and establishes a link to a central database. The central database may be located locally or remotely. Following a handshaking protocol, the host controller verifies identity and downloads the message to the database. Messages stored in the database are available for remote retrieval by the customer. In one embodiment, the message is deleted from the host and if not retrieved within a predetermined time, from the database.

In one embodiment, the designated party may choose to screen their incoming call based on the identity of the caller. For example, the designated party may choose not to accept an interactive telephone call from the host controller. In this case, the designated party may choose to monitor any incoming message after a voice prompt. The host controller plays the outgoing greeting message and begins to receive and record the caller's message as well as delivering the message to the resident. In one embodiment, the resident may press a button on the keypad to allow the designated party to talk to caller, thus, enabling an interactive audio link. In one embodiment, the designated party may opt to discard message which will terminate the call.

The outgoing greeting message may be stored on the host controller or it may be stored at the database. In one embodiment, the host controller establishes a three-party communication link between the doorbell location (caller), the database, and the designated party. In one embodiment, stored messages are retrieved by accessing the central database using a telephone and following voice prompts.

In one embodiment, the present subject matter includes a video image storage and retrieval system. For example, a video camera is adapted to capture a video image and sound for storage on the central database and later retrieval by a designated party.

In one embodiment, a digital camera may be mounted near (or be an integral component of) a door intercom module. When a doorbell button is pressed, one or more image frames of the visitor are captured and sent by BLUETOOTH® protocol link to the host controller. In one embodiment, the image data is downloaded to a central database. Audio data may also be captured and stored. In one embodiment, the capturing of data occurs during predetermined time periods such as, for example, between the time of door bell button pressing and host (or designated party) response. The stored date may be relayed to the database. Video and audio data may further be used within the premise when triggered by intrusion events such as activation of a motion sensor.

The image and audio data may prove helpful in identifying an intruder. The images or audio may be retrieved from the database upon request or on a scheduled service. The data may be delivered by e-mail or retrievable using a secure website.

Conclusion

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

By way of example, the present system may be installed and operated in a manner that allows a caller at the exterior side of a front entry door to communicate with a homeowner. The homeowner may be located within the building or may be remotely located and communicating using a telephone or other device. The technology of the present subject matter allows the homeowner to communicate with the caller without revealing to the caller that the homeowner is not local, thus providing a measure of protection or security for the homeowner.

What is claimed is:

1. An apparatus comprising:
a microphone;
an audio amplifier coupled to the microphone;
a speaker coupled to the audio amplifier and adapted for generating a sound audible at about a room-sized distance from the speaker;
a processor coupled to the audio amplifier;
a set of executable instructions accessible to the processor, the set of instructions adapted for causing the processor to recognize a voice received by the microphone and to generate a digital command in response thereto; and
a spread spectrum frequency hopping transceiver coupled to the processor and adapted for wirelessly communicating digital data.

2. The apparatus of claim 1 further comprising a connector coupled to the processor wherein the connector is adapted for receiving a signal from a motion detector.

3. The apparatus of claim 1 further comprising a user operable control coupled to the processor and adapted for specifying a destination for the digital data transmitted by the transceiver.

4. The apparatus of claim 1 further comprising a user operable button coupled to the processor and adapted for causing the transceiver to transmit digital data when pushed.

5. The apparatus of claim 1 further comprising a user operable button coupled to the processor and adapted for causing the transceiver to transmit digital data corresponding to audio received by the microphone when pushed.

6. The apparatus of claim 1 wherein the set of executable instructions includes instructions to identify a source of digital data received by the transceiver.

7. The apparatus of claim 1 wherein the transceiver operates at a frequency of approximately 2.45 GHz.

8. The apparatus of claim 1 wherein the transceiver is substantially compatible with standards under IEEE 802.15.

9. The apparatus of claim 1 wherein the transceiver is substantially compatible with BLUETOOTH® technical specification version 1.0.

10. The apparatus of claim 1 further comprising a squelch control adapted for muting a signal from the audio amplifier corresponding to a sound pressure level at the microphone below a predetermined level.

11. The apparatus of claim 10 wherein the predetermined sound pressure level is user selectable.

12. The apparatus of claim 1 further comprising a housing adapted for mounting with an electrical box listed by Underwriters Laboratories Inc.

13. The apparatus of claim 12 wherein the housing includes an electrical switch.

14. The apparatus of claim 12 wherein the housing includes an electrical outlet.

15. The apparatus of claim 12 wherein the housing includes an electrical box cover plate.

16. The apparatus of claim 1 further comprising a connector coupled to the amplifier, processor and transceiver and adapted for coupling with a metered electric service outlet.

17. The apparatus of claim 1 further comprising a battery connector coupled to the amplifier, processor and transceiver and adapted for coupling with a battery.

18. The apparatus of claim 17 wherein the battery connector is adapted for coupling with a rechargeable battery.

19. A method of manufacturing comprising:
coupling a microphone and a speaker to an audio amplifier having sufficient power to operate the speaker at a level such that a sound produced by the speaker is audible throughout a room;
coupling a processor to the audio amplifier;
coupling a spread spectrum frequency hopping transceiver to the processor;
coupling a power source connector to the audio amplifier, processor and transceiver; and
providing instructions accessible to the processor and adapted for causing the processor to instruct the transmitter to wirelessly transmit digital data based on local audio proximate the microphone and adapted for wirelessly receiving digital data based on remote audio and adapted for recognizing a voice received by the microphone and for generating a digital command in response thereto.

20. The method of claim 19 further comprising coupling a connector to the processor wherein the connector is adapted for receiving a signal from a motion detector.

21. The method of claim 19 further comprising providing instructions accessible to the processor to cause the processor to instruct the transceiver to transmit a predetermined message based on an input received by the processor.

22. The method of claim 19 further comprising assembling the audio amplifier, processor and transceiver in a housing adapted for mounting using an electrical box listed by Underwriters Laboratories Inc.

23. A method of communicating comprising:
transmitting a request to receive an identification number of a compatible transceiver within a predetermined range using a first spread spectrum frequency hopping transceiver;
receiving the identification number for the compatible transceiver;
receiving local audio;
digitizing the local audio having a sound pressure level above a predetermined threshold;
transmitting the digitized local audio to the compatible transceiver using the first transceiver;
receiving digital data corresponding to remote audio from the compatible transceiver using the first transceiver; and
playing the remote audio on a local speaker such that the sounds are audible within the space of about a room.

24. The method of claim 23 further comprising:
receiving a signal from a motion detector coupled to the processor; and
transmitting a digital signal based on the signal from the motion detector to the compatible transceiver.

25. The method of claim 23 further comprising:
receiving a signal from a user accessible control;
generating a request to establish bidirectional communications based on receipt of the received signal;
transmitting the request to the compatible transceiver;
receiving a reply from the compatible transceiver; and
modulating a local speaker based on the reply.

26. The method of claim 23 further comprising:
receiving the digitized local audio at a gateway; and
transmitting the received digitized local audio using a cellular telephone communication protocol.

27. The method of claim 23 further comprising:
receiving the digitized local audio at a gateway; and
transmitting the received digitized local audio using a pager communication protocol.

28. A method comprising:
playing an audible tone upon detecting a switch activation at an entry door associated with a premises having an entry door audio module;
determining occupancy of the premises;
if the premises is vacant, dialing a predetermined telephone number and establishing a first bidirectional communication channel linking the telephone number with the entry door audio module; and
otherwise, establishing a second bidirectional communication channel linking the entry door audio module with a second audio module.

29. The method of claim 28 wherein playing an audible tone includes playing an audible tone using the entry door audio module.

30. The method of claim 28 wherein determining occupancy includes receiving a signal from a security system.

31. The method of claim 28 wherein establishing a first bidirectional communication channel includes prompting to record a message.

32. The method of claim 28 wherein establishing a first bidirectional communication channel includes recording an audio message received at the entry door audio module.

33. The method of claim 28 wherein establishing a second bidirectional communication channel includes recording an audio message received at the entry door audio module.

34. The method of claim 28 wherein establishing a first bidirectional communication channel includes conducting communications using a protocol compatible with BLUETOOTH® technical specification version 1.0.

35. The method of claim 28 wherein establishing a second bidirectional communication channel includes conducting communications using a protocol compatible with BLUETOOTH® technical specification version 1.0.
